(19) United States
(12) Patent Application Publication
(10) Pub. No.: US 2006/0017904 A1
(43) Pub. Date: Jan. 26, 2006

(54) Method and apparatus for photolithographic exposure using a redirected light path for secondary shot regions

(76) Inventor: Kyoung Ho Kim, Gyeonggi-do (KR)

Correspondence Address: MYERS BIGEL SIBLEY & SAJOVEC, PO BOX 37428, RALEIGH, NC, 27627, US

(21) Appl. No.: 11/185,632

(22) Filed: Jul. 20, 2005

(30) Foreign Application Priority Data
Jul. 23, 2004 (KR) 2004-57631

(51) Int. Cl. G03B 27/54

(52) U.S. Cl. 355/67; 355/53

(57) ABSTRACT

Photolithographic exposure methods and apparatus are provided wherein light from an illumination source is processed to produce light beams having substantially parallel paths and substantially identical densities. The light beams are passed through a reticle to expose a first object on a microelectronic substrate. The light beams are redirected to bypass the reticle and expose a second object on the microelectronic substrate. The first object may include a first shot region, such as a device region, defined on a photoresist film on the substrate. The second object may include a second shot region, such as an edge shot region, defined on the photoresist film.

### CROSS REFERENCE TO RELATED APPLICATION

This application claims priority under 35 USC § 119 to Korean Patent Application No. 2004-57631, filed on Jul. 23, 2004, the contents of which are herein incorporated by reference in its entirety.

### BACKGROUND OF THE INVENTION

The present invention relates to methods and apparatus for exposing photosensitive materials and, more particularly, to methods and apparatus for exposing photosensitive material on a microelectronic substrate.

Semiconductor devices are typically manufactured using a plurality of processes, such as an ion implantation process, a deposition process, a diffusion process, and a photolithography process. A pattern may be formed on a semiconductor substrate by a photolithography process. A photolithography process typically includes a coating process for coating a photoresist solution on the semiconductor substrate, a baking process for baking the photoresist solution to form a photoresist film, an exposure process for transcribing a reticle pattern onto the photoresist film, and a developing process for forming a photoresist pattern corresponding to the reticle pattern on the semiconductor substrate.

An apparatus for performing an exposure process typically includes a light source, an illumination unit for converting a spot light into a surface light to condense the surface light, a first stage for supporting a reticle having a reticle pattern, a projection optical unit for irradiating the surface light passing through the reticle onto the semiconductor substrate, and a second stage for supporting the semiconductor substrate. The reticle typically is positioned over the projection optical unit. The semiconductor substrate typically is arranged under the projection optical unit.

Light emitted from the light source passes through the illumination unit and is converted into surface light. The surface light typically is then focused. The focused surface light typically is irradiated to the reticle. The light passing through the reticle includes image information of the reticle pattern. The light including the image information is irradiated onto the semiconductor substrate through the projection optical unit.

Shot regions of the semiconductor substrate into which the reticle pattern is transcribed typically have dimensions and numbers in accordance with the kinds of semiconductor devices being manufactured. The exposure process may be classified into a primary exposure process performed on the device regions and a secondary exposure process performed on edge portions of the semiconductor substrate. The secondary exposure process may be carried out on edge shot regions adjacent to the edge portions of the semiconductor substrate to selectively remove a photoresist film on the edge portions of the semiconductor substrate.

According to a conventional exposure process, a patterned reticle having a single pattern area may be used in the primary exposure process as an exposure mask. A non-patterned reticle without a pattern may be used in the secondary exposure process as an exposure mask.

Thus, to perform the secondary exposure process on a first semiconductor substrate, the patterned reticle may need to be exchanged for the non-patterned reticle after completing the primary exposure process. Also, to perform the primary exposure process on a second semiconductor substrate, the non-patterned reticle may be exchanged for the patterned reticle. Additionally, after the patterned reticle is exchanged for the non-patterned reticle and vice versa, an alignment process between the substrate and the exchanged reticle may need to be carried out. For example, when a unit lot includes twenty-five semiconductor substrates, fifty exchanging processes may be required to perform the exposure process on the twenty-five semiconductor substrates. Also, fifty alignment processes for the patterned reticle and the non-patterned reticle may also need to be carried out. This may cause decreasing accuracy in the exposure process and loss of time and money. As semiconductor devices have become highly integrated, the above-mentioned problem may become increasingly significant.

### SUMMARY OF THE INVENTION

According to some embodiments of the present invention, photolithographic exposure methods are provided. Light from an illumination source is processed to produce light beams having substantially parallel paths and substantially identical densities. The light beams are passed through a reticle to expose a first object on a microelectronic substrate. The light beams are redirected to bypass the reticle and expose a second object on the microelectronic substrate. The first object may include a first shot region, such as a device region, defined on a photoresist film on the substrate. The second object may include a second shot region, such as an edge shot region, defined on the photoresist film.

In further embodiments, processing light from an illumination source to produce light beams having substantially parallel paths and substantially identical densities includes passing the light beams through a reticle blind for the reticle. Redirecting the light beams to bypass the reticle and expose a second object on the microelectronic substrate may include redirecting the light beams after passage through the reticle blind. The light from the illumination source may be passed through a concave lens, a convex lens and a reticle blind to obtain the substantially parallel paths and substantially identical densities. The light beams may be focused using an aperture. Redirecting the light beams to bypass the reticle and expose a second object may include reflecting the light beams away from the reticle and towards the second object, e.g., by tilting a light-reflecting mirror arranged in line with the reticle. Exposure of the second object may include directing the reflected light beams to a blank blind having a light-transmitting region and irradiating the second object through the blank blind.

In additional embodiments of the present invention, a photolithography exposure apparatus includes a first light-supplying unit configured to direct light to a first object on a microelectronic structure through a reticle in a primary exposure process. The first light-supplying unit is further configured to produce light beams having substantially parallel paths and substantially identical densities. A second light-supplying unit is configured to redirect the light beams produced by the first light-supplying unit to bypass the reticle and irradiate a second object on the microelectronic substrate in a secondary exposure process. The first light-supplying unit may include a first optical unit configured to produce light beams having substantially parallel paths, a second optical unit configured to process the light beams having substantially parallel paths to produce light beams having substantially parallel paths and substantially identical densities, an illumination unit configured to irradiate the light beams produced from the second optical unit onto the reticle, and a first projecting unit configured to irradiate light beams passing through the reticle onto the first object. The first optical unit may include a fly eye lens, and the second optical unit may include a concave lens, a convex lens, a reticle blind and a condensing lens. The first light-supplying unit may further include a third optical unit arranged between the first and second optical units and including an aperture configured to focus light beams that pass through the second optical unit.

The second light-supplying unit may include a first tiltable mirror configured to reflect light beams produced from the first light-supplying unit and a second mirror configured to reflect light beams reflected from the first mirror. A second projecting unit may be configured to irradiate the second object with light beams reflected from the second mirror. The second projecting unit may include a blank blind having a light-transmitting region therein.

The apparatus may further include a controller configured to control the first and second light-supplying units to selectively perform the primary and secondary exposure processes. The controller may include a first optical measuring unit configured to detect an initial point and an endpoint of a first exposure process and a drive unit configured to position the first tiltable mirror in respective first and second positions in response to detection of the initial point and the endpoint. The controller may further include a second optical measuring unit for measuring an intensity of light beams reflected from the second object and may be configured to control a speed of a secondary exposure process in accordance with the intensity of the light beams. The apparatus may further include a stage configured to support the microelectronic substrate and controlled by the controller.

### BRIEF DESCRIPTION OF THE DRAWINGS

The above and other features and advantages of the invention will become readily apparent by reference to the following detailed description when considered in conjunction with the accompanying drawings wherein:

FIG. 1 is a flow chart illustrating exposure operations in accordance with some exemplary embodiments of the present invention;

FIG. 2 is a front view illustrating an exposure apparatus for performing the operations of FIG. 1;

FIG. 3 is a perspective view illustrating a blank blind system of the apparatus of FIG. 2; and

FIG. 4 is a plan view illustrating a semiconductor substrate processed using the apparatus of FIG. 2.

### DESCRIPTION OF EXEMPLARY EMBODIMENTS

The present invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or a layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

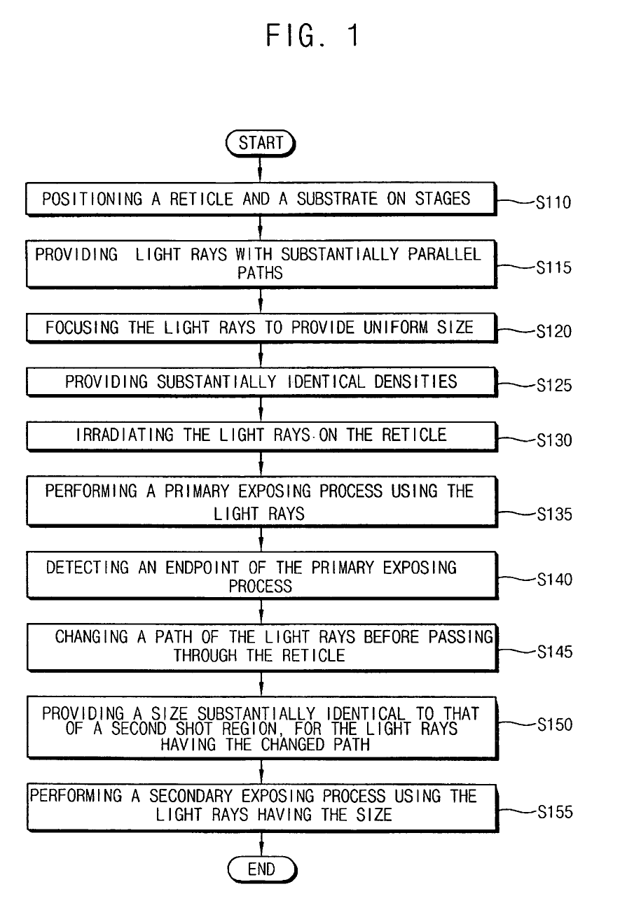

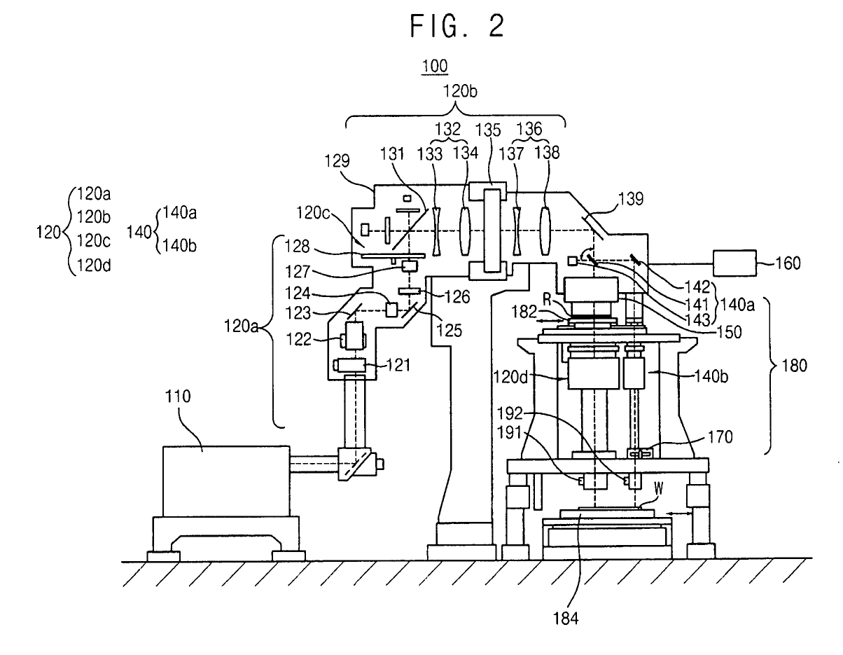

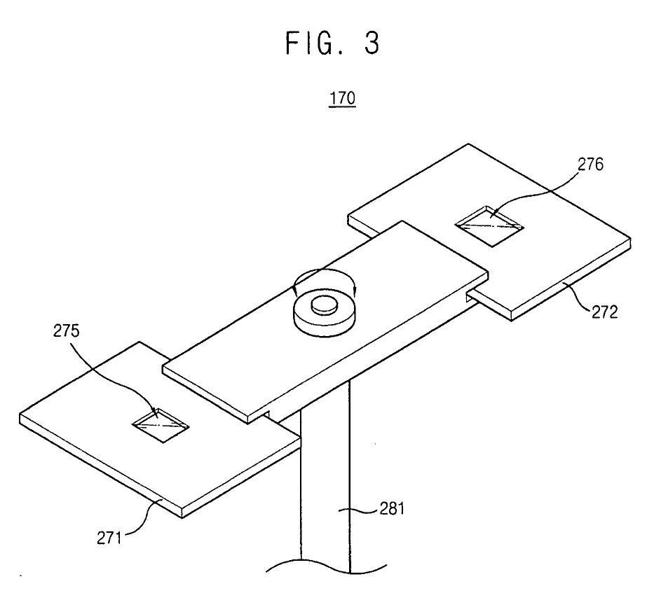

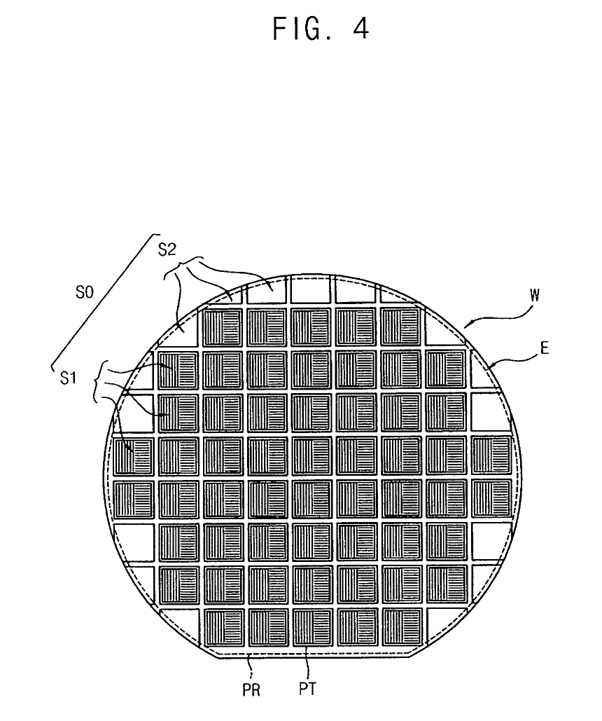

FIG. 1 is a flow chart illustrating exemplary exposure operations in accordance with some exemplary embodiments of the present invention, FIG. 2 is a front view illustrating an exposure apparatus configured to perform the operations of FIG. 1, FIG. 3 is a perspective view illustrating a blank blind system used in the apparatus of FIG. 2 and FIG. 4 is a plan view illustrating a semiconductor substrate processed using the operations and apparatus in FIG. 2. Referring to FIGS. 2 and 4, photoresist is coated on a semiconductor substrate W. The photoresist is soft baked to form a photoresist film PR on the semiconductor substrate W. A plurality of shot regions S0 is defined on the semiconductor substrate W having the photoresist film PR.

The shot regions S0 are divided into a first shot region S1 and a second shot region S2. The photoresist film PR on the first shot region S1 is exposed and developed to form a photoresist pattern PT. The second shot region S2 includes the rest of the shot regions S0 except for the first shot region S1. The second shot region S2 borders an edge E of the semiconductor substrate W. The photoresist film PR on the second shot region S2 is removed by exposure and developing processes. The first shot region S1 may have a size that varies in accordance with kinds of semiconductor devices being formed. Also, the configuration of the second shot region S2 may vary in accordance with the configuration of the first shot region S1. In the illustrated embodiments, the photoresist film PR on the first shot region S1 corresponds to a first object to be exposed and the photoresist film PR on the second shot region S2 corresponds to a second object to be exposed.

An exposure apparatus 100 includes a light source 110, a first light-supplying unit 120, a second light-supplying unit 140, a controlling unit 160 and a stage unit 180. The light source 110 emits light beams (or rays) for exposing the first and second shot regions S1 and S2. Examples of the light source 110 may include, but are not limited to, a mercury lamp, an ArF laser emitter, a KrF laser emitter, an extreme ultraviolet beam emitter, and an electron beam emitter. The light source 110 is connected to the first light-supplying unit 120.

The first light-supplying unit 120 includes a first optical unit 120a, a second optical unit 120b, a third optical unit 120c and a first projecting unit 120d. A first stage 182 for supporting a reticle R is arranged between the second optical unit 120b and the first projecting unit 120d. The reticle R is positioned on the first stage 182. A second stage 184 for supporting the semiconductor substrate W is positioned under the first projecting unit 120d. The semiconductor substrate W is placed on the second stage 184.

The first optical unit 120a includes a variable beam attenuator 121, a beam shaping optical system 122, a first mirror 123, a first fly-eye lens 124, a second mirror 125, a condensing lens 126 and a second fly-eye lens 127. The second optical unit 120b includes a beam splitter 131, a first alignment system 132, a reticle blind 135, a second alignment system 136 and a third mirror 139. The first alignment system 132 includes a first concave mirror 133 and a first convex mirror 134. The second alignment system 136 includes a second concave mirror 137 and a second convex mirror 138 having sizes greater than those of the respective first concave mirror 133 and first convex mirror 134.

The third optical unit 120c includes an aperture 128. The third optical unit 120c is arranged between the first and second optical units 120a and 120b. A housing 129 encloses the first, second and third optical units 120a, 120b and 120c.

The light beams emitted from the light source 110 have substantially parallel paths and substantially identical densities. In particular, the light beams emitted from the light source 110 pass through the first optical unit 120a to produce the parallel paths. The light beams passing through the first optical unit 120a pass through the third optical unit 120c so that the light beams are focused. The light beams passing through the third optical unit 120c are aligned by the first alignment system 132 of the second optical unit 120b to have the substantially identical densities. The light beams aligned by the first alignment system 132 pass through the reticle blind 135 to produce a specific wavelength and a transmittance area. Values accurately reflecting image information of a reticle pattern on the reticle R may be selected as the specific wavelength and the transmittance area of the light beams. The light beams interfered by the reticle blind 135 are re-aligned by the second alignment system 136. The light beams passing through the second alignment system 136 have substantially identical paths, substantially identical wavelengths and substantially identical densities. That is, the light beams that pass through the first optical unit 120a, the third optical unit 120c and the second optical unit 120b may have optimal characteristics, such as a quantity of a light, an intensity of a light, and/or a density of a light, for forming the photoresist pattern PT. The optimal characteristics may be selected in accordance with an aspect ratio and an etching selectivity of a structure to be formed on the semiconductor substrate W.

The quantity and the density of the light beams passing through the second alignment system 136 is less than those of the light beams emitted from the light source 110. The light beams emitted from the light source 110 are inappropriate for the exposure process. For example, because the light beams emitted from the light source 110 may have a high luminance, a thin photoresist pattern PT may not be formed using the light beams. Also, because the light beams emitted from the light source 110 may have irregular paths having a high reflexibility, an efficiency of the exposure process may be decreased and a pre-formed photoresist pattern PT may be damaged.

The light beams passing through the second alignment system 136 are reflected from the third mirror 139. The reflected light beams are irradiated onto the reticle R through the illumination unit 150. The illumination unit 150 includes a condensing lens (not shown). The illumination unit 150 is positioned over the reticle R.

The light beams passing through the reticle R have the image information of the reticle pattern. The light beams passing through the reticle R are projected onto the first shot region S1 through the first projecting unit 120d. Here, the light beams passing through the reticle R are focused to have a size corresponding to that of the first shot region S1. Thus, a reduced image of the reticle pattern is transcribed into the first shot region S1.

When a primary exposure process is performed on the photoresist film PR on the first shot region S1, the primary exposure process may be carried out by a scanning process in which the reticle R and the semiconductor substrate W are moved in opposite directions. The reticle R is moved using the first stage 182 and the semiconductor substrate W is moved using the second stage 184. The controlling unit 160 controls the first and second stages 182 and 184. Alternatively, the primary exposure process may be performed by a stepper process.

To accurately perform the primary exposure process, movement velocities of the first and second stages 182 and 184 are controlled in accordance with an intensity of light beams reflected from the semiconductor substrate W. A first optical measuring unit 191 measures the intensity of the light beams reflected from the semiconductor substrate W.

The first optical measuring unit 191 is mounted on the first projecting unit 120d to face the semiconductor substrate W. The controlling unit 160 controls the movement velocities of the first and second stages 182 and 184 in accordance with a reflexibility of the light beams measured by the first optical measuring unit 191. The first optical measuring unit detects an initial point and an endpoint of the first exposure process.

The second light-supplying unit 140 includes a light path-changing unit 140a and a second projecting unit 140b. The light path-changing unit 140a is arranged between the third mirror 139 and the illumination unit 150. The second projecting unit 140b is positioned over the second stage 184 in parallel with the first projecting unit 120d.

The light-path changing unit 140a includes a first light-reflecting mirror 141, a second light-reflecting mirror 142 and a driving unit 143. The first light-reflecting mirror 141 is tiltably positioned on a path of the light beams reflected from the third mirror 139. The driving unit 143 controls a tilting angle of the first light-reflecting mirror 141. The controlling unit 160 controls the driving unit 143. The driving unit 143 positions the first light reflecting mirror 141 on the region at the initial point of the first exposure process. The driving unit 143 removes the first light-reflecting mirror 141 from the region at an initial point of another first exposure process after having successively carried out the first exposure process.

When the first light-reflecting mirror 141 is tilted to a first position, the light beams reflected from the third mirror 139 are irradiated to the illumination unit 150 without being interfered with by the first light-reflecting mirror 141. When the first light-reflecting mirror 141 is tilted to a second position, the light beams reflected from the third mirror 139 are reflected from the first light-reflecting mirror 141 toward the second light-reflecting mirror 142. The light beams reflected from the second light-reflecting mirror 142 are irradiated to the second projecting unit 140b. The light beams passing through the second projecting unit 140b are irradiated onto the second shot region S2. Additionally, the second projecting unit 140b may include a light-condensing member (not shown).

Referring to FIG. 3, a blank blind system 170 includes a first blank blind 271, a second blank blind 272 and a rotary driving unit 281. The first and second blank blinds 271 and 272 each have a plate shape and have a light-transmitting region therein. In particular, the first blank blind 271 has a first light-transmitting region 275 and the second blank blind 272 has a second light-transmitting region 276. The first light-transmitting region 275 has a size different from that of the second light-transmitting region 276. The sizes of the first and second light-transmitting regions 275 and 276 may vary in accordance with the size of the second shot region S2, that is, the first and second blank blinds 271 and 272 correspond to reticles for exposing the second shot region S2.

The first and second blank blinds 271 and 272 are detachably secured to both sides of the rotary driving unit 281. The first and second blank blinds 271 and 272 rotate with respect to a central axis of the rotary driving unit 281. A secondary exposure process may be performed using one of the first and second blank blinds 271 and 272 that has a size corresponding to that of the second shot region S2 to be exposed. As a result, the exposure process may be completed in a relatively short time. In the illustrated embodiment, the blank blind system 170 includes the first and second blank blinds 271 and 272. Alternatively, the blank blinds system 170 may vary in accordance with a size of the exposure apparatus 100.

To reduce damage to the photoresist pattern PT, a quantity and an intensity of the light beams irradiated onto the second shot region S2 may be controlled in accordance with an intensity of the light beams reflected from the semiconductor substrate W. A second optical measuring unit 192 measures the intensity of the light beams reflected from the semiconductor substrate W. The second optical measuring unit 192 is mounted on the second projecting unit 140b to face the semiconductor substrate W. The controlling unit 160 controls a velocity of the second stage 184 in accordance with the reflexibility of the light beams measured by the second optical measuring unit 192.

Korean Patent Laid Open Publication No. 1999-017136 discloses a method of reducing a time required for an exposure process. According to the above Korean Publication, all of the light beams emitted from a light source may be used for exposing a second shot region. However, because the light beams may have a high luminance and a high reflexibility, an efficiency of the exposure process may be decreased and a photoresist pattern on a first shot region may be damaged.

On the contrary, according to the present embodiment, the light beams used for exposing the first shot region S1 are substantially identical to those used for exposing the second shot region S2. Thus, the light beams for exposing the second shot region S2 have a reflexibility lower than that of the light beams disclosed in the above Korean Publication so that damage to the photoresist pattern PT on the first shot region S1 may be limited in the secondary exposure process. As a result, the first and second exposure processes may be rapidly completed and efficiencies of the first and second exposure processes may be improved.

FIG. 1 is a flow chart illustrating an exposing method using the apparatus in FIG. 2. Referring to FIG. 1, in step S10, the reticle R and the semiconductor substrate W are placed on the first stage 182 and the second stage 184, respectively. The semiconductor substrate W has a photoresist film PR formed thereon. A plurality of shot regions S0 is defined on the semiconductor substrate W having the photoresist film PR.

The shot regions S0 are divided into the first shot region S1 and the second shot region S2. The first shot region S1 corresponds to the first object and the second shot region S2 corresponds to the second object. The photoresist film PR on the first shot region S1 is exposed and developed to form the photoresist pattern PT. The second shot region S2 borders the edge E of the semiconductor substrate W. The photoresist film PR on the second shot region S2 is removed by exposure and developing processes.

In step S115, the light beams emitted from the light source 110 are processed to provide substantially parallel paths for the light beams. Here, the light beams emitted from the light source 110 may include, for example, a mercury light, a laser beam, an extreme ultraviolet beam, or an electron beam. To provide the paths for the light beams, the first optical unit 120a including the variable beam attenuator 121, the beam shaping optical system 122, the first mirror 123, the first fly-eye lens 124, the second mirror 125, the condensing lens 126 and the second fly-eye lens 127 may be used.

Because the light beams emitted from the light source 110 may have a high luminance, the light beams emitted from the light source 110 may be inappropriate for the exposure process. Particularly, the light beams emitted from the light beam source may be inappropriate for forming a thin photoresist pattern or a structure having a high aspect ratio.

In step S120, the light beams are then focused to provide uniform sizes to the light beams. Here, to provide the uniform sizes to the light beams, the third optical unit 120c including the aperture 128 may be used.

In step S125, the focused light beams are processed to provide substantially identical densities for the focused light beams. The second optical unit 120b including the beam splitter 131, the first alignment system 132, the reticle blind 135, the second alignment system 136 and the third mirror 139 provide the densities to the focused light beams. The first alignment system 132 includes the first concave mirror 133 and the first convex mirror 134. The second alignment system 136 includes the second concave mirror 137 and the second convex mirror 138.

The light beams have a specific wavelength and transmittance area. Here, the values accurately reflecting the image information of the reticle pattern on the reticle R may be selected as the specific wavelength and the transmittance area of the light beams. That is, the light beams may have optimal characteristics such as a quantity of a light, an intensity of a light, and/or a density of light, for forming the photoresist pattern PT. The optimal characteristics may be selected in accordance with a thickness of the desired photoresist pattern PT, an aspect ratio and an etching selectivity of a structure to be formed on the semiconductor substrate W.

In step S130, the light beams are irradiated to the reticle R. The light beams passing through the reticle R include the image information of the reticle pattern.

In step S135, the light beams including the image information are irradiated onto the first shot region S1 to form the photoresist pattern PT. When the primary exposure process is performed on the photoresist film PR on the first shot region S1, the primary exposure process may be carried out by a scanning type in which the reticle R and the semiconductor substrate W are moved in opposite directions.

In step S140, an endpoint of the primary exposure process is detected. The endpoint may correspond to a point of time for alternatively performing the primary and secondary exposure processes. For example, when the second shot region S2 is positioned under the second projecting unit 140b in moving the semiconductor substrate W, a point of time at which the primary exposure process on the first shot region S1 is completed may be selected as the endpoint.

In the illustrated embodiments, the endpoint corresponds to a point of time for exposing the first and second shot regions S1 and S2 with the semiconductor substrate W being minimally moved. Alternatively, after the entire shot region S1 is exposed, the second shot region S2 may be exposed.

In step S145, the light beams having the paths and the densities are redirected to the second shot region S2 using the light path-changing unit 140a.

In step S150, to limit damage of the photoresist pattern PT on the first shot region S1 in performing the secondary exposure process, the redirected light beams are processed using the blank blind system 170 to provide a size corresponding to that of the second shot region S2, for the redirected light beams. Here, the light beams used in the primary exposure process are substantially identical to those used in the secondary exposure process. Thus, the light beams used in the secondary exposure process have a relatively low reflexibility, such that the damage of the photoresist pattern PT on the first shot region S1 may be limited. In step S55, the redirected light beams are irradiated onto the second shot region S2 to perform the secondary exposure process.

Although the light beams emitted from the light source are used in the secondary exposure process, the light beams, if unprocessed, might damage the photoresist pattern due to the high luminance of the light beams. However, in the illustrated embodiments, the light beams substantially identical to each other are used in the primary and secondary exposure processes so that the damage of the photoresist pattern PT may be limited. Also, the primary and secondary exposure processes may be completed in a short time so that an efficiency of the exposure process may be improved.

According to some embodiments of the present invention, the primary and secondary exposure processes may be performed without exchanging reticles so that the primary and secondary exposure processes may be completed in a short time. Also, because light beams having the substantially parallel paths and densities by unit area are used in the primary and secondary exposure processes, the damage of the photoresist pattern may be limited.

Having described exemplary embodiments of the present invention, it is noted that modifications and variations can be made by persons skilled in the art in light of the above teachings. It is therefore to be understood that changes may be made in the particular embodiment of the present invention disclosed which is within the scope and the spirit of the invention outlined by the appended claims.

What is claimed is:

1. A photolithography exposure method comprising:
processing light from an illumination source to produce light beams having substantially parallel paths and substantially identical densities;
passing the light beams through a reticle to expose a first object on a microelectronic substrate; and
redirecting the light beams to bypass the reticle and expose a second object on the microelectronic substrate.

2. The method of claim 1, wherein the first object comprises a first shot region defined on a photoresist film on the substrate and wherein the second object comprises a second shot region defined on the photoresist film.

3. The method of claim 2, wherein the first shot region comprises a device region and wherein the second shot region comprises an edge shot region.

4. The method of claim 1, wherein processing light from an illumination source to produce light beams having substantially parallel paths and substantially identical densities comprises passing the light beams through a reticle blind for the reticle, and wherein redirecting the light beams to bypass the reticle and expose a second object on the microelectronic substrate comprises redirecting the light beams after passage through the reticle blind.

5. The method of claim 1, wherein processing light from the illumination source comprises passing the light through a concave lens, a convex lens and a reticle blind to obtain the substantially parallel paths and substantially identical densities.

6. The method of claim 5, further comprising focusing the light beams using an aperture.

7. The method of claim 1, wherein redirecting the light beams to bypass the reticle and expose a second object comprises reflecting the light beams away from the reticle and towards the second object.

8. The method of claim 7, wherein reflecting the light beams away from the reticle and towards the second object comprises tilting a light-reflecting mirror arranged in line with the reticle.

9. The method of claim 7, wherein redirecting the light beams to bypass the reticle and expose a second object further comprises:
directing the reflected light beams to a blank blind having a light-transmitting region; and
irradiating the second object through the blank blind.

10. The method of claim 1, further comprising moving the second object transverse to the light beams.

11. The method of claim 10, wherein a velocity of transverse movement of the second object is controlled in accordance with an intensity of the reflected light beams.

12. A photolithography exposure apparatus comprising:
a first light-supplying unit configured to direct light to a first object on a microelectronic structure through a reticle in a primary exposure process, wherein the first light-supplying unit is further configured to produce light beams having substantially parallel paths and substantially identical densities; and
a second light-supplying unit configured to redirect the light beams produced by the first light-supplying unit to bypass the reticle and irradiate a second object on the microelectronic substrate in a secondary exposure process.

13. The apparatus of claim 12, wherein the first object comprises a first shot region defined on a photoresist film on the substrate and wherein the second object comprises a second shot region defined on the photoresist film.

14. The apparatus of claim 13, wherein the first shot region comprises a device region and wherein the second shot region comprises an edge shot region.

15. The apparatus of claim 12, wherein the first light-supplying unit comprises:
a first optical unit configured to produce light beams having substantially parallel paths;
a second optical unit configured to process the light beams having substantially parallel paths to produce light beams having substantially parallel paths and substantially identical densities;
an illumination unit configured to irradiate the light beams produced from the second optical unit onto the reticle; and
a first projecting unit configured to irradiate light beams passing through the reticle onto the first object.

16. The apparatus of claim 15, wherein the first optical unit comprises a fly eye lens, and wherein the second optical unit comprises a concave lens, a convex lens and a reticle blind.

17. The apparatus of claim 15, wherein the second optical unit comprises a condensing lens.

18. The apparatus of claim 15, wherein the first light-supplying unit further comprises a third optical unit arranged between the first and second optical units and including an aperture configured to focus light beams that pass through the second optical unit.

19. The apparatus of claim 15, wherein the second light-supplying unit comprises:
a first tiltable mirror configured to reflect light beams produced from the first light-supplying unit;
a second mirror configured to reflect light beams reflected from the first mirror; and
a second projecting unit configured to irradiate the second object with light beams reflected from the second mirror.

20. The apparatus of claim 19, wherein the second projecting unit comprises a blank blind having a light-transmitting region therein.

21. The apparatus of claim 20, wherein the light-transmitting region has a size substantially identical to that of the first object or the second object.

22. The apparatus of claim 19, further comprising a controller configured to control the first and second light-supplying units to selectively perform the primary and secondary exposure processes, wherein the controller comprises:
a first optical measuring unit configured to detect an initial point and an endpoint of a first exposure process; and
a drive unit configured to position the first tiltable mirror in respective first and second positions in response to detection of the initial point and the endpoint.

23. The apparatus of claim 22, wherein the controller further comprises a second optical measuring unit for measuring an intensity of light beams reflected from the second object and is configured to control a speed of a secondary exposure process in accordance with the intensity of the light beams.

24. The apparatus of claim 12, further comprising a controller configured to control the first and second light-supplying units to selectively perform the primary and secondary exposure processes.

25. The apparatus of claim 24, further comprising a stage configured to support the microelectronic substrate and controlled by the controller.
